(19) United States
(12) Patent Application Publication
(10) Pub. No.: US 2006/0081252 A1
(43) Pub. Date: Apr. 20, 2006

(54) Headgear

(76) Inventor: Thomas J. Wood, Blackshear, GA (US)

Correspondence Address: Keady, Olds & Maier, PLLC, PO Box 1817, Alexandria, VA, 22313, US

(21) Appl. No.: 10/967,251

(22) Filed: Oct. 19, 2004

(51) Int. Cl. A62B 17/04; A62B 18/08

(52) U.S. Cl. 128/207.11; 128/201.22

(57) ABSTRACT

A headgear device is described which includes a plurality of flexible straps for easy adjustment and adaptation to support various devices worn on the head. In one embodiment the headgear can be adapted to be connected to a positive pressure ventilation system.

### BACKGROUND OF THE INVENTION

1. Field of the Invention

Exemplary embodiments of the invention are directed to a headgear device and in particular to a headgear device adaptable to be connected to positive pressure ventilation system.

2. Discussion of Related Art

Headgear apparatus is used to support a variety of devices that are fitted to or adjacent to the head of a user. The headgear can be independent of the device or integrated into the device. Examples include facemasks, hardhats, helmets, goggles, visual devices, breathing devices, and the like. U.S. Pat. No. 6,341,382, entitled “One-Piece Adjustable Headgear Support”, discloses a one-piece adjustable headgear strap that is constructed of lightweight material. The strap is constructed with an adjustment mechanism that enables it to be easily adjusted around the head of wearer using one hand. Additionally, the adjustment mechanism is integrally formed with the headband of the headgear support to reduce cost of construction.

Further, headgear devices that are used for medical conditions or situations where the user tends to wear the device for a long time should be designed to for both support and comfort. A particularly challenging application in the use of headgear to be connected to a ventilation interface for treating sleep apnea. However, the invention is not limited to this application.

Obstructive sleep apnea syndrome (commonly referred to as obstructive sleep apnea, sleep apnea syndrome, and/or sleep apnea) is a medical condition which includes repeated, prolonged episodes of cessation of breathing during sleep. During a period of wakefulness, the muscles of the upper part of the throat passage of an individual keep the passage open, thereby permitting an adequate amount of oxygen to flow into the lungs. During sleep, the throat passage tends to narrow due to the relaxation of the muscles. In those individuals having a relatively normally sized throat passage, the narrowed throat passage remains open enough to continue to permit the adequate amount of oxygen to flow into the lungs. However, in those individuals having a relatively smaller sized throat passage, the narrowed throat passage prohibits the adequate amount of oxygen from flowing into the lungs. Additionally, a nasal obstruction, such as a relatively large tongue, and/or certain shapes of the palate and/or the jaw of the individual further prohibit the adequate amount of oxygen from flowing into the lungs.

The individual having the above-discussed conditions can stop breathing for one or more prolonged periods of time (e.g., 10 seconds or more). The prolonged periods of time during which breathing is stopped, or apneas, are generally followed by sudden reflexive attempts to breathe. The reflexive attempts to breathe are generally accompanied by a change from a relatively deeper stage of sleep to a relatively lighter stage of sleep. As a result, the individual suffering from obstructive sleep apnea syndrome generally experiences fragmented sleep that is not restful. The fragmented sleep results in one or more of excessive and/or inappropriate daytime drowsiness, headache, weight gain or loss, limited attention span, memory loss, poor judgment, personality changes, lethargy, inability to maintain concentration, and/or depression.

Other medical conditions can also prevent individuals, including adults and infants, from receiving the adequate amount of oxygen into the lungs. For example, an infant who is born prematurely can have lungs that are not developed to an extent necessary to receive the adequate amount of oxygen. Further, prior to, during, and/or subsequent to certain medical procedures and/or medical treatments, an individual can be unable to receive the adequate amount of oxygen.

Under these circumstances, it is known to use a ventilation interface to apply a positive pressure to the throat of the individual, thereby permitting the adequate amount of oxygen to flow into the lungs. In the known ventilation interface, oxygen and/or room air containing oxygen is delivered through the mouth and/or nose of the individual. Known types of positive pressure applied by the known ventilation interface include continuous positive airway pressure (CPAP) in which a positive pressure is maintained in the throat passage throughout a respiratory cycle, bi-level positive airway pressure (BiPAP) in which a relatively high positive pressure is maintained during inspiration and a relatively low positive pressure is maintained during expiration, and intermittent mechanical positive pressure ventilation (IPPV) in which a positive pressure is applied when apnea is sensed (i.e., the positive airway pressure is applied intermittently or non-continuously).

A headgear device for a ventilation interface is disclosed in U.S. Pat. No. 6,341,382, entitled “Continuous Positive Airway Pressure Headgear”. The CPAP headgear disclosed ha a relatively complex assembly of components including a head cover, a lip strap, clips an/or extenders to hold the CPAP respiratory mask in place. The head cover is designed with two side portions, each encircling an ear with an open area. One side of the headgear separates into two straps that connect across the top of the head to the second side. Another strap comes from the back of the left side that encircles the ear and around the nape, thereby connecting the two headpieces together across the nape of the neck. The lip strap extends from both lower sides in front of the ears and is attached from one side of the headgear to the other, and is placed below and on the lower lip cooperating to help keep the wearer's lower lip against the teeth. The clip is a bent hook that attaches to the side strap from the headgear to the respiratory mask attachment. The extenders are attachments that are part of a mask or can be or a bent wire attached to an existing respiratory masks. The extenders may take the place of the clip.

As can be appreciated from the foregoing discussion, headgear to support these ventilation interfaces should be as comfortable as possible so as not to interrupt the sleep cycle and should be easily adjustable to adapt to a variety of users and/or positions for a given user. Accordingly, it is desirable to provide an improved headgear.

### SUMMARY OF EMBODIMENTS OF THE INVENTION

An exemplary embodiment of the invention includes a headgear device is which includes a plurality of flexible straps for easy adjustment and adaptation to support various devices worn on the head.

Another exemplary embodiment of the invention includes headgear adapted to be connected to a positive pressure ventilation system.

An exemplary embodiment of the invention includes a headgear apparatus including a headband including a first end and a second end, wherein said first end has a first fastening element and said second end has a second fastening element configured to cooperate with said first fastening element in an adjustable manner; an overhead strap including at least one open end, wherein said at least one open end including a first fastening element and a second element fastening element adjacent said first fastening element configured to cooperate with said first fastening element in an adjustable manner; and at least one interface strap supported by the headband, wherein the at least one interface strap includes an open end, wherein said open end includes a first fastening element and a second fastening element adjacent said first fastening element configured to cooperate with said first fastening element in an adjustable manner.

Another exemplary embodiment includes a ventilation system including a nasal cannula including at least one headgear connector; and a headgear device, wherein said headgear device further includes a headband including a first end and a second end, wherein said first end has a first fastening element and said second end has a second fastening element configured to cooperate with said first fastening element in an adjustable manner; an overhead strap including at least one open end, wherein said at least one open end including a first fastening element and a second element fastening element adjacent said first fastening element configured to cooperate with said first fastening element in an adjustable manner, and at least one interface strap supported by the headband, wherein the at least one interface strap includes an open end, wherein said open end includes a first fastening element and a second fastening element adjacent said first fastening element configured to cooperate with said first fastening element in an adjustable manner.

Further scope of applicability of embodiments of the present invention will become apparent from the detailed description given hereinafter. However, it should be understood that the detailed description and specific examples are given by way of illustration only, since various changes and modifications within the spirit and scope of the invention will become apparent to those skilled in the art from this detailed description.

### BRIEF DESCRIPTION OF THE DRAWINGS

Reference will now be made to the exemplary embodiments of the invention, examples of which are illustrated in the accompanying drawings. Wherever possible, the same reference numbers will be used throughout the drawings to refer to the same or like parts

FIG. 1 illustrates a front elevation view of an exemplary embodiment of a headgear apparatus;

FIG. 2 illustrates a top view of the headgear apparatus of FIG. 1;

FIG. 3 illustrates a front elevation view of another exemplary embodiment of a headgear apparatus;

FIG. 4 illustrates a front elevation view of a nasal cannula including connectors for connecting to headgear;

FIG. 5 illustrates an exploded side elevation view of an exemplary embodiment of a ventilation interface system;

FIG. 6 illustrates a front elevation view of another exemplary embodiment of a headgear apparatus; and

FIG. 7 illustrates a front elevation view of another exemplary embodiment of a headgear apparatus.

Other embodiments of the invention will be apparent to those skilled in the art from consideration of the specification and practice of the invention disclosed herein. It is intended that the specification and examples be considered as exemplary only, with the scope of the invention being indicated by the following claims.

### DETAILED DESCRIPTION OF THE EXEMPLARY EMBODIMENTS

Aspects of the invention are disclosed in the following description and related drawings directed to specific embodiments of the invention. Alternate embodiments may be devised without departing from the spirit or the scope of the invention. Additionally, well-known elements of the invention will not be described in detail or omitted so as not to obscure the relevant details of embodiments of the invention.

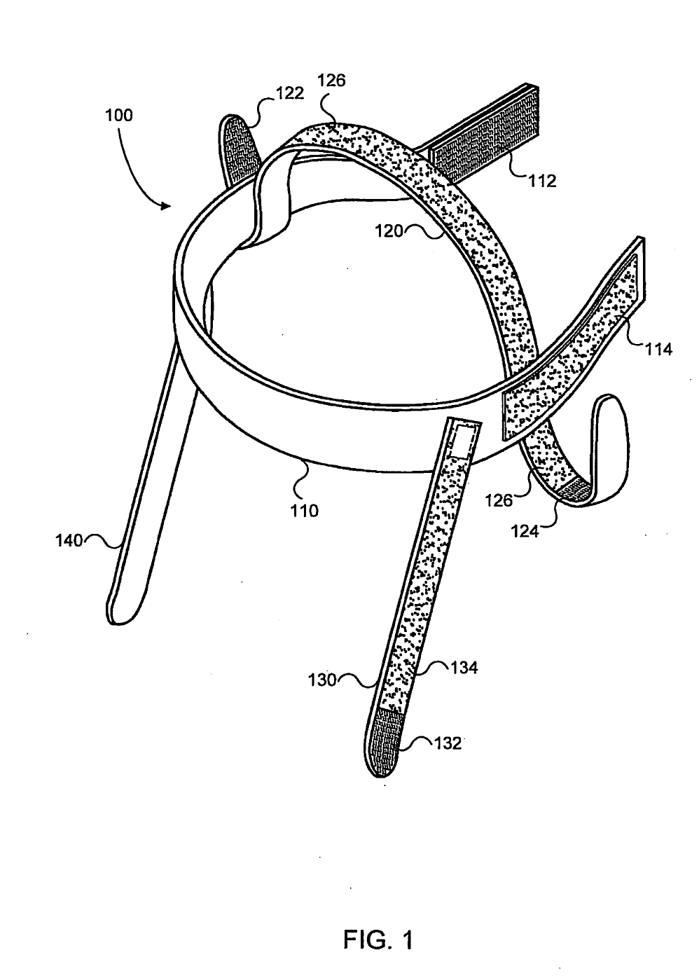

Referring to FIG. 1, a left front elevation of an exemplary embodiment of the invention is illustrated. The headgear 100 can include a headband portion 110 that is adjustable to fit around the circumference of a user's head. An adjustable overhead strap 120 can be provided for looping over the top of the user's head. Further, at least one interface strap 130, 140 can be provided to support a device. The headband 110 is typically made from a soft pliable material to provide a comfortable interface to the user's head. The headband 110 can be provided in with two open ends that are fitted with an adjustable fastening element 112 and 114 that allows for easy adjustment of the headband 110. For example, as illustrated, the adjustable fastening elements 112 and 114 can be a hook and loop type fastener having cooperating fastening elements 112 and 114 on each end, respectively. The fastening elements 112 and 114 allow for easy adjustment of the headband 110 to fit a variety of head diameters. Additionally, the fastening elements 112 and 114 as illustrated (e.g., Velcro®) can provide for a smooth overlapping fastening region that prevents pressure points from developing, which further enhances the comfort of the headgear 100. However, those skilled in the art will appreciate that the fastening elements are not limited to hook and loop type fasteners. Any other conventional fastening element can be used such as snaps, buttons, clasps, latches, buckles, loops, adhesive and the like.

Likewise, overhead strap 120 can be provided with two open ends that are fitted with an adjustable fastening elements 122 and 126 that allows for easy adjustment of the overhead strap 120. For example, as illustrated, the adjustable fastening elements 122, 124 and 126 can be a hook and loop type fasteners, wherein the elements 122 and 126 work cooperatively with fastening element 124. The fastening elements 122, 124 and 126 allow for easy adjustment of the overhead strap to fit a variety of head sizes. Further, fastening elements 122, 124 and 126 of overhead band 120 allow for easy adjustment of the location of headband 110. Additionally, the fastening elements 122, 124, and 126 as illustrated (e.g., Velcro®) can provide for a smooth overlapping fastening region that prevents pressure points from developing, which further enhances the comfort of the headgear 100. However, those skilled in the art will appreciate that the fastening elements are not limited to hook and loop type fasteners. Any other conventional fastening element can be used such as snaps, buttons, clasps, latches, buckles, loops, adhesive and the like.

At least one interface strap 130, 140 is provided that can be supported from the headband 110. Interface strap 130 can be fastened to the headband 110 in any conventional manner, non-limiting examples including stitching, adhesive, snaps, buttons, latches, hook and loop fasteners and the like. The opposite end of the interface strap 130 includes a first fastening element 132. Adjacent to the first fastening element 132 is a second the first fastening element 134 configured to cooperate with the first fastening element 132 in an adjustable manner. Additionally, the first fastening element 132 of the interface strap can be configured to attach to a device (not shown) worn on a head by simply looping the interface strap 130 through and/or around a connection element (e.g., flange, fitting, post, and the like). The actual fastening loop can be formed by folding the first fastening element 132 back onto the adjacent second fastening element 134, which works in cooperation with the first fastening element 132 to secure the device. Once again, those skilled in the art will appreciate that the fastening elements are not limited to hook and loop fasteners (e.g., Velcro®). Any other conventional fastening element can be used such as snaps, buttons, clasps, latches, buckles, loops, adhesive and the like.

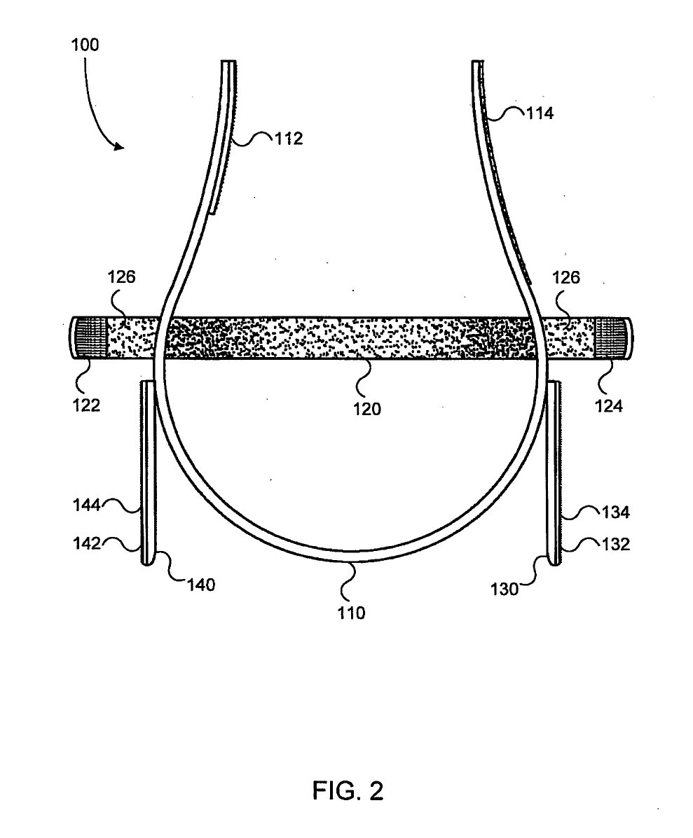

An additional interface strap 140 can be provided that is similar to interface strap 130, which provides additional support for head worn devices. Accordingly, interface strap 140 can be fastened to the headband 110 in any conventional manner, non-limiting examples including stitching, adhesive, snaps, buttons, latches, hook and loop fasteners and the like. The opposite end of the interface strap 140 includes a first fastening element 142 (see, FIG. 2). Adjacent to the first fastening element 142 is a second the first fastening element 144 configured to cooperate with the first fastening element 142 in an adjustable manner. Additionally, the first fastening element 142 of the interface strap can be configured to attach to a device (not shown) worn on a head by simply looping the interface strap 130 through and/or around a connection element (e.g., flange, fitting, post, and the like). The actual fastening loop can be formed by folding the first fastening element 142 back onto the adjacent second fastening element 144, which works in cooperation with the first fastening element 142 to secure the device. Once again, those skilled in the art will appreciate that the fastening elements of the are not limited to hook and loop fasteners (e.g., Velcro®). Any other conventional fastening element can be used such as snaps, buttons, clasps, latches, buckles, loops, adhesive and the like.

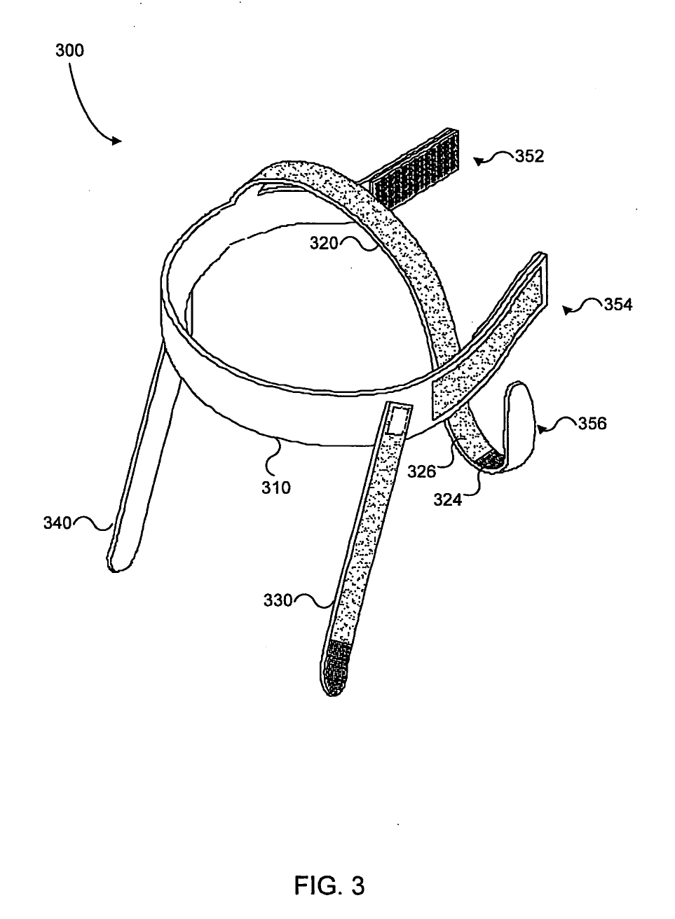

FIG. 3 illustrates an alternate embodiment of the headgear apparatus 300. In this embodiment overhead strap 320 is attached or integral with the headband 310 on one end. The other end is left open for adjusting the strap length and relative position of the headband 310. The open end is fitted with an adjustable fastening element 326 that works in cooperation with fastening element 324 to allow for easy adjustment of the overhead strap 320. For example, as illustrated, the adjustable fastening elements 324 and 326 can be a hook and loop type fasteners. The fastening elements 324, and 326 (e.g., Velcro®) can provide for a smooth overlapping fastening region that prevents pressure points from developing. However, those skilled in the art will appreciate that the fastening elements are not limited to hook and loop type fasteners. Any other conventional fastening element can be used such as snaps, buttons, latches, loops and the like. The remaining elements of headgear 300 are similar to those elements of headgear 100 discussed in detail in the foregoing description.

The headgear 100 is illustrated as being formed of multiple individual pieces that can be easily configured to form the headgear apparatus 100. The headband, overhead strap, and at least one interface strap can be made of a similar material of similar characteristics such as flexibility, elasticity and the like. Using similar material can reduce the cost of inventory for production purposes. However, embodiments of the invention are not limited to this construction and differing materials can be used for each component.

Alternatively, the headgear apparatus 300 can have an integrated construction. For example, the headband 310 and overhead strap 320 can be integrated into one piece as illustrated in FIG. 3 including three open ends 352, 354, and 356 to allow for adjustment of the headgear apparatus. Still further, the headgear interface straps 330, 340 can be integrated into the one piece, thereby forming a one piece headgear unit including at least four open ends to allow for adjusting the headgear apparatus and securing a device (e.g., nasal cannula) to the headgear apparatus. The headgear apparatus can also be formed from one common piece of material, thus minimizing the number of individual components.

As discussed above, devices that are used for medical conditions present additional challenges in providing headgear that provides adequate support but is also comfortable and unobtrusive for the user. A particularly challenging application in the use of headgear to be connected to a ventilation interface for treating sleep apnea. However, those skilled in the art will appreciate that the invention is not limited to this application. Accordingly, the following description illustrates other exemplary embodiments of the invention.

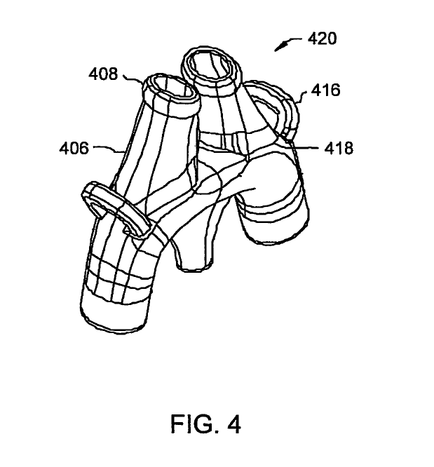

FIG. 4 illustrates an elevated front view of a nasal cannula 420. In particular, in the cannula 420 can include at least one headgear connector 416. As previously described, the cannula 420 can be held in place by headgear (such as described in the foregoing description), which is attached to the U-shaped headgear connector 416. The headgear connector 416 can be attached to an exterior portion of the cannula 420, such as at the connection portion 418. Headgear 100 can attach to the headgear connector 16 and/or connection portion 418 via looping the interface strap (e.g., 130) through the open portion of connector 416 and adjusting the position of and securing the cannula by connecting fastening elements 132 and 134. For example, this can be accomplished by looping the open end of interface strap 130 through connector 16 and then pressing the hook and loop fasteners (132 and 134) together once a secure and comfortable position has been established.

In the particular nasal cannula 420 illustrated a sealing bead 408 can be provided on nasal insert 406 that functions to both seal against the nares and provides additional support for the nasal cannula 410 and ventilation system (not shown). Although it is not required, a nasal cannula 420 that provides a self-supporting function can work in cooperation with the headgear. This provides support for the ventilation system (e.g., nasal cannula, ventilation tubing, and the like) and reduces any concentration of pressure on the nasal passages and portions of the head in contact with the headgear. The foregoing nasal cannula is provided for purposes of illustration as to a device the headgear apparatus can support and should not be construed in any limiting manner regarding either the type of device the headgear can support or the manner of interface to the device supported.

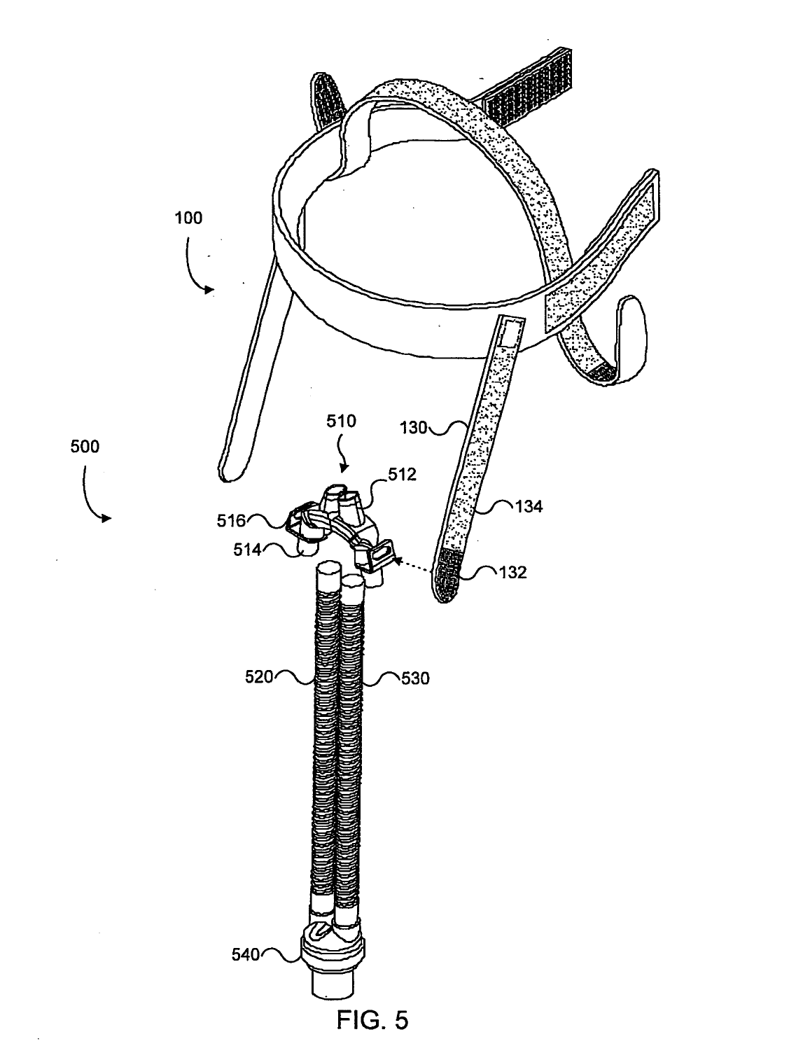

FIG. 5 shows an exploded side elevation view of an embodiment of a ventilation interface system 500 including a headgear apparatus according to at least one embodiment of the present invention. In an exemplary embodiment, the invention can provide a ventilation interface system adapted to be inserted into a nares of a user to secure the interface. A cannula 510 adaptable to be connected to a source of ventilation gas (not shown) forms a first portion of an input gas flow passage to supply the ventilation gas to the user. Nasal inserts 512 are adapted to be inserted into the nares of the user forms a second portion of the input gas flow passage from the cannula to a distal end of the nasal insert 512. A seal portion (see, e.g., FIG. 4, reference 8) can be optionally adapted to engage a portion of the nares of the user is positioned at the distal end of the nasal insert 512. The cannula 510 can include an end 514 connectable to the source of the ventilation gas via at least one feed tube (520, 530). In an exemplary embodiment of the invention, a y-connector 540 that can be connected with the source of the ventilation gas at one end and to the feed tubes 520 and 530 at the other end.

Although the figures show certain exemplary embodiments of the cannula 510, it is to be understood that the cannula 510 can be of any type, so long as the cannula 510 is capable of being supported by the headgear apparatus discussed above. For example, the exemplary embodiment illustrated in FIG. 5 shows a headgear connector 516 that fits over the connection end 514 of nasal cannula 510 and thereby provides support at the connecting location of the cannula 510 and the feed tubes 520 and 530. As can be seen, connector 516 includes an open portion that allows for headgear 100 to attach to the headgear connector 516. For example, the interface strap 130 can be looped through the open portion of connector 516. The cannula 510 can be secured and positioned by connecting fastening elements 132 and 134. For example, this can be accomplished by looping the open end of interface strap 130 through connector 516 and then pressing the hook and loop fasteners (132 and 134) together once a secure and comfortable position has been established.

Accordingly, as illustrated in this configuration, the headgear apparatus can be adjusted to fit the user and the adjustment can be maintained even if the cannula is removed. For example, the removable connectors can be left attached to the headgear interface and the headgear left in place on a user's head, while disengaging the connectors from the nasal cannula. When the cannula is reinserted into the nasal cavity, the removable connectors still attached to the headgear apparatus can be reconnected to the cannula Thus, the prior adjustment of the headgear can be maintained.

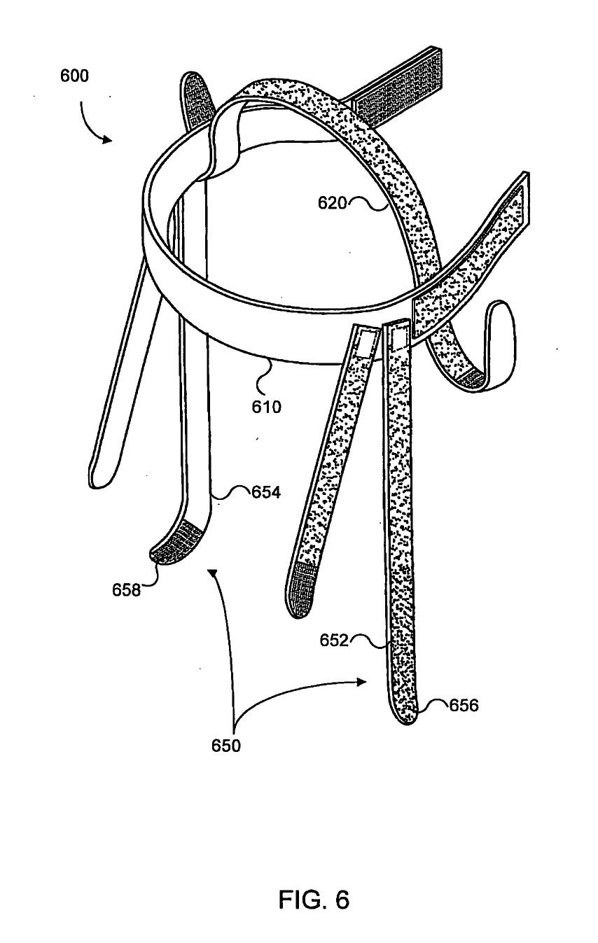

Referring to FIG. 6, at lease one additional embodiment of the invention is illustrated. Once again, a complete rendition of all elements of illustrated in headgear 600 will not be provided as similar features were previously described in relation to FIGS. 1, 2 and 3. Likewise, the various modifications illustrated herein are merely exemplary in nature and are not intended to limit the combinations of features as disclosed herein, as will be appreciated by those skilled in the art. For example, the overhead strap illustrated in FIG. 6 is similar to that of FIG. 1. However, the integrated overhead strap and headband configuration of FIG. 3 could readily be adapted to the embodiment of FIG. 6, as will be appreciated by those skilled in the art. Accordingly, all combinations and sub-combinations of the elements illustrated and described herein are considered to be within the scope of the invention.

FIG. 6 illustrated at least one embodiment of the invention further including a chinstrap 650 formed by straps 652 and 654. The chinstrap 650 can provided for additional support for the headgear 600. Chinstrap 650 generally resists movement in a direction opposite to overhead strap 620 and thus resists movement of headband 610 toward in the direction of overhead strap 620. Additionally, chinstrap 650 can be configured and adjusted to provide positive pressure to the jaw area, so as to reduce the likelihood that the mouth will open. Maintaining a closed mouth can increase the effectiveness of nasal ventilation devices.

As illustrated in FIG. 6, the chinstrap 650 can be formed from two separate straps 652 and 654. Each strap can have fastening elements 656 and 658, respectively, that facilitate adjustment of the chinstrap 650. Alternatively, a single strap can be used for chinstrap 650 and connected in a similar fashion as the overhead strap in either FIG. 1 or 3. Further, although hook and loop type fastening elements are illustrated, fastening elements 656 and 658 can be any type, such as snaps, buttons, clasps, latches, buckles, loops, adhesive and the like.

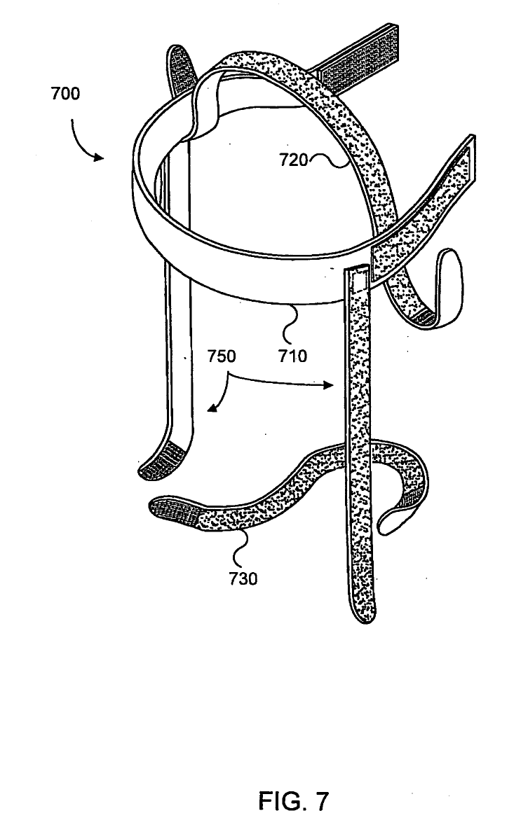

FIG. 7 illustrates another embodiment of the invention. In this embodiment, the headgear apparatus 700 includes at least one interface strap 730 that configured to attach to the chinstrap 750. The chinstrap 750 is coupled to the headband 710 and provides support in direction opposite that of overhead strap 720. Further, as illustrated, interface strap 730 can be configured to attach to the chinstrap 750 in an adjustable manner (e.g., hook and loop fastener). This allows the location of the interface strap 730 to be relocated along an axial length of the chinstrap 750. Accordingly, the angle of the interface strap 750 relative to device supported (e.g., nasal cannula) can easily be adjusted. This additional adjustment to the headgear can further increase the comfort for the user and/or support of the device. Further, additional interface straps can easily be added and adjusted to increase the support of a device. For example, four interface straps can be provided and positioned two on each chinstrap with attachment points located above and below the device on each side. Accordingly, both the up and down movement of the device can be controlled.

Numerous additional modifications and variations of the exemplary embodiment of the present invention are possible in light of the above teachings. It is therefore to be understood that within the scope of the appended claims, exemplary embodiments of the present invention may be practiced otherwise than as specifically described herein.

What is claimed is:

1. A headgear apparatus comprising:
a headband including a first end and a second end, wherein said first end has a first fastening element and said second end has a second fastening element configured to cooperate with said first fastening element in an adjustable manner;
an overhead strap including at least one open end, wherein said at least one open end includes a first fastening element and a second element fastening element adjacent said first fastening element configured to cooperate with said first fastening element in an adjustable manner; and
at least one interface strap supported by the headband, wherein the at least one interface strap includes an open end, wherein said open end includes a first fastening element and a second fastening element adjacent said first fastening element configured to cooperate with said first fastening element in an adjustable manner.

2. The headgear apparatus of claim 1, wherein the overhead strap further comprises:
a second open end including a third fastening element and a fourth fastening element adjacent said third fastening element configured to cooperate with said third fastening element in an adjustable manner.

3. The headgear apparatus of claim 2, wherein the second and fourth fastening elements are integrated into one continuos fastening element.

4. The headgear apparatus of claim 1, wherein the fastening elements are hook and loop type fasteners.

5. The headgear apparatus of claim 1, wherein the fastening elements are at least one of hook and loop type fasteners, snaps, buttons, clasps, latches, buckles, loops, and adhesive.

6. The headgear apparatus of claim 1, wherein the least one interface strap is attached to the headband at an opposite end to the open end.

7. The headgear apparatus of claim 6, wherein the least one interface strap is attached to the headband by at least one of stitching, glue, hook and loop type fasteners, snaps, buttons, latches, and loops.

8. The headgear apparatus of claim 1, wherein the headband, overhead strap, and at least one interface strap are made of a similar material.

9. The headgear apparatus of claim 1, wherein the headband and overhead strap are integrated into one piece including three open ends to allow for adjustment of the headgear apparatus.

10. The headgear apparatus of claim 9, wherein the at least one interface strap integrated into the one piece, thereby forming a one piece headgear unit including at least four open ends to allow for adjusting the headgear apparatus and securing a device to the headgear apparatus.

11. The headgear apparatus of claim 10, wherein the headgear apparatus is formed from one common piece of material.

12. The headgear apparatus of claim 1, further comprising a chinstrap.

13. The headgear apparatus of claim 1, wherein the chinstrap is formed from two straps each strap fixed to the headband on one end and having a fastening element on the opposite end.

14. The headgear apparatus of claim 12, wherein the at least one interface strap is configured to attach to the chinstrap and wherein the chinstrap is coupled to the headband.

15. The headgear apparatus of claim 14, wherein the at least one interface strap configured to attach to the chinstrap in an adjustable manner that allows the location of the at least one interface strap to be relocated along an axial length of the chinstrap.

16. A ventilation system comprising:
a nasal cannula including at least one headgear connector; and
a headgear device, wherein said headgear device comprises:
a headband including a first end and a second end, wherein said first end has a first fastening element and said second end has a second fastening element configured to cooperate with said first fastening element in an adjustable manner;
an overhead strap including at least one open end, wherein said at least one open end including a first fastening element and a second element fastening element adjacent said first fastening element configured to cooperate with said first fastening element in an adjustable manner, and
at least one interface strap supported by the headband, wherein the at least one interface strap includes an open end, wherein said open end includes a first fastening element and a second fastening element adjacent said first fastening element configured to cooperate with said first fastening element in an adjustable manner.

17. The ventilation system claim 16, further comprising:
at least one feed tube operably coupled to the nasal cannula and coupled to a ventilation device, thereby allowing positive pressure ventilation to the nasal cannula.

18. The ventilation system claim 16, wherein the headgear device further comprises:
a second open end on the overhead strap, the second open end including a third fastening element and a fourth fastening element adjacent said third fastening element configured to cooperate with said third fastening element in an adjustable manner.

19. The ventilation system claim 16, wherein the at least one headgear connector is integrated into the cannula.

20. The ventilation system claim 16, wherein the at least one headgear connector is configured to be detachable from the cannula.
